(19) United States
(12) Patent Application Publication
(10) Pub. No.: US 2018/0209206 A1
(43) Pub. Date: Jul. 26, 2018

(54) Trackless Free-Swinging Bi-fold Door

(71) Applicant: Lawrence Castaldi, III, Boca Raton, FL (US)

(72) Inventor: Lawrence Castaldi, III, Boca Raton, FL (US)

(21) Appl. No.: 14/569,781

(22) Filed: Dec. 14, 2014

Related U.S. Application Data
(60) Provisional application No. 62/054,919, filed on Sep. 24, 2014.

(51) Int. Cl. E06B 3/48; E05D 15/26; E05F 1/12

(52) U.S. Cl. CPC E06B 3/488; E06B 3/481; E05F 1/12; E05D 15/266; E06B 3/486

(57) ABSTRACT

A trackless free-swinging bi-fold door that eliminates the standard guide tracks of conventional bi-fold doors and replaces them with two pivot pin hinges, a simple door modification and a magnet catch. The door modification consists of a spring mechanism connecting the two door panels. The door can be opened as a straight swinging door, and as a conventional bi-fold door. A hinge attaches the door to a door panel that allows the door to swing entirely out of the way of the door portal.

### CROSS-REFERENCE TO RELATED APPLICATIONS

This application is related to, and claims the benefit of, the provisional patent application entitled “Trackless Free-Swinging Bi-fold Door”, filed Sep. 24, 2014, bearing U.S. Ser. No. 62/054,919 and naming Lawrence Castaldi, III, the named inventor herein, as sole inventor, the contents of which is specifically incorporated by reference herein in its entirety.

### BACKGROUND

1. Technical Field

This invention relates in general to folding doors. In particular, it relates to a folding door that can be installed without guide tracks and which can also operate as a single, or alternatively, as a double panel door.

2. Background of the Invention

Residences and/or commercial offices often require the use of storage space. For example, pantries, linen closets, storage cabinets, etc., are important storage areas that are used in almost buildings, both commercial and residential. Typically, these storage areas require a means to enclose them when not in use.

One prior art method of enclosing storage areas is to use sliding doors. Sliding doors, sometimes referred to as bypass doors, have a disadvantage in that they typically take up more than fifty percent of the opening, and thereby limit access to the storage area. In addition, sliding doors also require rigid guide tracks to guide them when they are moved. As a result, they provide limited functionality and are costly to manufacture and install due to the guide tracks. It would be desirable to have a door that provides greater access to a storage area.

An alternative prior art solution was the development of conventional bi-fold doors. Bi-fold doors are widely used on closets, pantry doors, and other access doors. They overcome a disadvantage of sliding doors because they provide greater access storage areas. In addition, they do not have to open out into a room as far as a straight swinging door. This allows bi-fold doors to be used in locations where a straight swinging door would not work.

While a conventional bi-fold door overcomes major disadvantages of a sliding door, it also has several disadvantages. One of the biggest disadvantages of bi-fold doors is that they fold back on the inside of the door opening. This is especially problematic with small door openings such as 18, 24, and 30-inches because the thickness of the door limits the area of access. A conventional tracked bi-fold door installed properly will typically take up about 5 inches of the available door opening. That means a 24-inch pantry or linen closet opening will yield only about 19-inches of access space when fully open. As a result, the door takes up over 20% of the potential access to the closet, or other storage area, and dramatically reduces the accessibility and functionality of the closet. An 18-inch closet opening loses almost 30% of the available opening space because access with typical bi-folds installed is limited to about only 13-inches. It would be desirable to have a bi-fold door that did not reduce the access space as much as conventional bi-fold doors.

Another important drawback of bi-fold for doors is that they rely on metal guide tracks to guide the door movement. These guide tracks are expensive to manufacture, they waste material unnecessarily, they are cumbersome and labor-intensive to install, and they inevitably fail because the hardware binds up as the tracks corrode, bend and wear. It would be desirable to have a bi-fold door that did not require guide tracks.

While the prior art has provided basic sliding door and folding door designs, it has failed to provide a door that provides maximum access to a storage area, and can be installed without the use of conventional door guide tracks.

### SUMMARY OF THE INVENTION

This invention provides a trackless free-swinging bi-fold door that replaces the standard guide tracks of conventional bi-fold doors with two pivot pin hinges, a simple door modification and a magnet catch. The door modification consists of holes drilled into the back of the door panels with a spring mechanism, (metal or elastic). The spring mechanism is simple but has two purposes: 1) it holds the 2 door panels on a single plane, so the door can be opened as a straight swinging door, and 2) retracts the door into a fully compressed (flat,) open position when the door is engaged as a conventional bi-fold door.

### BRIEF DESCRIPTION OF THE DRAWINGS

FIG. 1 illustrates a preferred embodiment of the trackless bi-fold door in the closed configuration.

FIG. 2 illustrates a top view of a preferred embodiment of the trackless bi-fold door in the bi-fold open configuration.

FIG. 3 illustrates a preferred embodiment of the trackless bi-fold door in the straight door open configuration.

FIG. 4 illustrates a preferred embodiment of the trackless bi-fold door in the straight door open configuration showing items secured to the back of the trackless bi-fold door.

FIG. 5 illustrates a preferred embodiment of the spring mechanism in the trackless bi-fold door that retains the door panels in the bi-fold or straight door configurations.

FIG. 6 illustrates a top view of a preferred embodiment of the trackless bi-fold door secured to the doorjamb by the magnet assembly on the door panel and a magnet on the doorjamb when the trackless bi-fold door is in the closed configuration.

FIG. 7 illustrates an end view of an alternative preferred embodiment of the trackless bi-fold door in which the spring mechanism is a conventional spring in place of the bungee spring shown in previous embodiments.

FIG. 8 illustrates a front view of an alternative preferred embodiment of the trackless bi-fold door in which the conventional slats on the trackless bi-fold door, shown in previous embodiments, are replaced by solid panels such as mirrors, artwork, or other materials.

FIGS. 9A-B illustrate top edge views of an alternative preferred embodiment of the trackless bi-fold door in which a hinge moves the door panels entirely out of the way of the entry the trackless bi-fold door covers.

FIG. 9C illustrates a front view of the preferred embodiment of the hinge used by the trackless bi-fold door.

### DETAILED DESCRIPTION OF THE PREFERRED EMBODIMENT

Prior to a discussion of the figures, an overview of the invention will be presented. For ease of discussion, the term “closet” will be used to describe any form of storage area that requires a folding door, such as a closet, pantry, storage area, etc. The trackless free-swinging bi-fold closet door described herein provides the benefits of a conventional bi-fold door while eliminating several of its drawbacks and adding several novel benefits. Among its benefits, this door takes up much less of the door opening, is easier and less expensive to install, is cheaper to produce and ship, and can open either as a bi-fold or a straight swinging door.

The trackless bi-fold door described herein improves the conventional bi-fold door. In particular, it allows the bi-fold door to open more fully by removing clumsy hardware; it eliminates the guide tracks on conventional bi-fold doors and uses a simple spring mechanism that retracts the doors completely to allow better closet access; it further uses the spring mechanism to connect the two panels of the bi-fold in a plane so the door can also function as a straight swinging door; and it keeps the doors in place when closed without the need for any tracks. The bi-fold doors taught herein offer superior and unique benefits of flexibility, practicality, reduced costs, use and ergonomics over other doors.

In particular, the trackless bi-fold doors provide the following benefits:

1—The trackless bi-fold door is easier to install because it does not require two tracks or even one; it requires none. This eliminates the measuring and cutting of metal tracks as well as the measuring, drilling and installation knowledge to install.
2—The trackless bi-fold door is cheaper to produce because there are no tracks and less hardware such as screws to manufacture.
3—The trackless bi-fold door is quicker to install because there is less hardware and installation knowledge required.
4—The trackless bi-fold door is more versatile because it can be used in a larger variety of applications; taking the place of both bi-fold doors and/or straight swinging doors while providing the benefits of a door that can do both.
5—The trackless bi-fold door reduces manufacturers shipping costs because it eliminates metal parts that are heavy.
6—The trackless bi-fold door offers superior access into closet taking up only 1.25 inches of space on the inside of the door opening in the swinging position and only 2.5 inches of space in the bi-fold position where conventional bi-folds take up to 5 inches or more.
7—The trackless bi-fold door, when placed in the straight door configuration, can open up fully so the back of the door can be used for storage with the use of hooks, pockets or other storage accessories. Conventional bi-folds do not allow access to the back of the door.
8—The trackless bi-fold door is more reliable because there is less hardware to malfunction.
9—The trackless bi-fold door, when in the bi-fold configuration, can be used in tight spaces where a straight swinging door would conflict with obstacles such as furniture, other doors and opposing walls such as in a narrow hallway, and alternatively, when in the straight door configuration, can be used as a conventional single panel door where the back of the door and also be used to suspend items for storage.

Having discussed the invention in general, we turn now to a detailed discussion of the drawings.

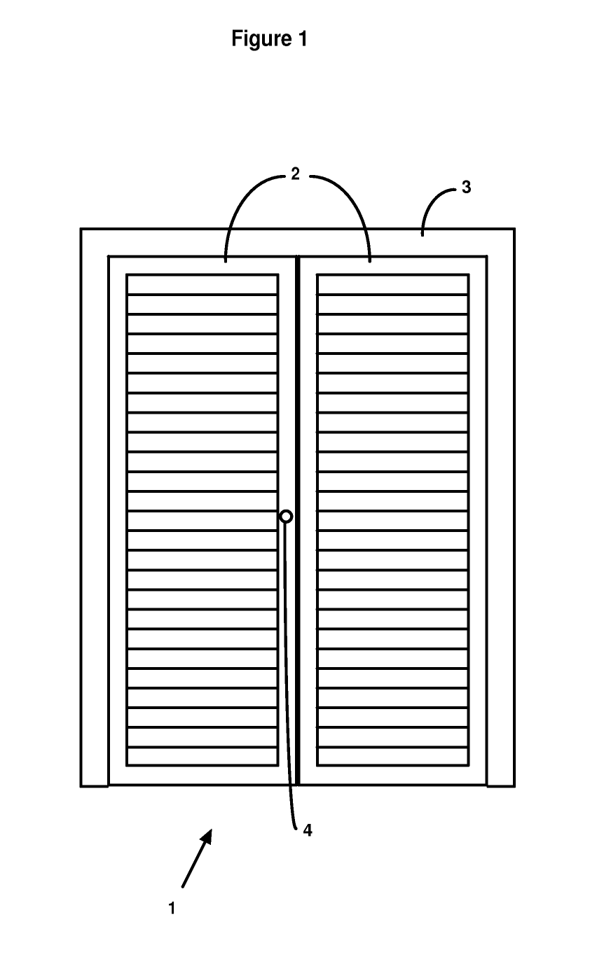

FIG. 1 illustrates a preferred embodiment of the trackless bi-fold door 1 in the closed configuration. In the closed configuration, the trackless bi-fold door 1 appears to be a conventional prior art bi-fold door. The trackless bi-fold door 1 as two door panels 2 that are sized to fit within a conventional doorjamb 3. Also show is doorknob 4.

While the figure illustrates the door panels 2 as louvered panels, those skilled in the art will recognize that any convenient door design can be used. Likewise, the material used to fabricate the trackless bi-fold door 1 can be any suitable material depending on design choices.

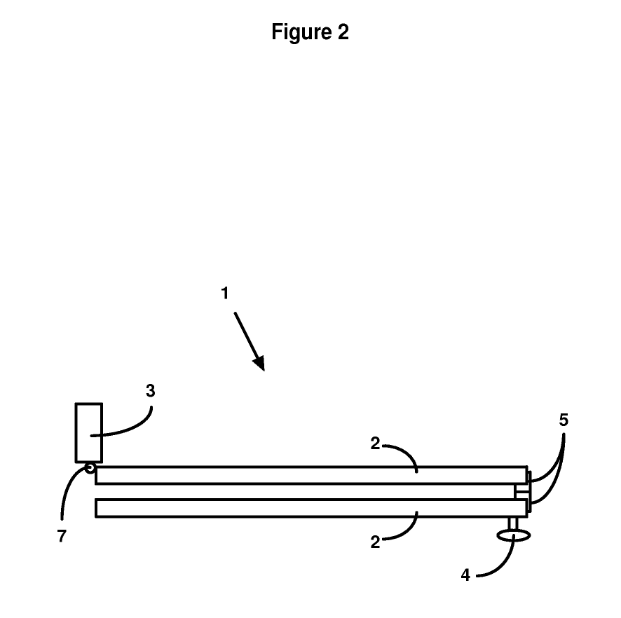

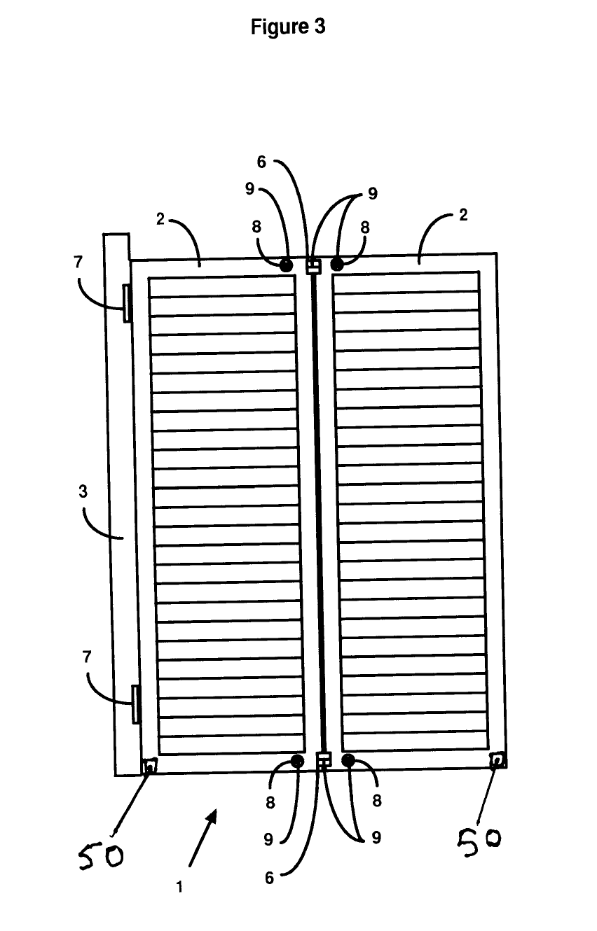

FIG. 2 illustrates a top view of a preferred embodiment of the trackless bi-fold door 1 in the bi-fold open configuration. This view shows the trackless bi-fold door 1 in the open bi-fold configuration. The trackless bi-fold door 1 is shown attached to the doorjamb 3 via doorjamb hinge 7. The two door panels 2 are folded together by door panel hinge five 5. A retention mechanism, the spring 9 (shown below in regard to FIG. 3), holds the trackless bi-fold door 1 in the selected position.

Access to the closet or pantry can be further improved through the use of a doorjamb hinge 7 that positions the bi-fold door 1 away from the doorjamb 3 such that an individual has unobstructed access to the closet or pantry. A unique hinge design is used in this alternative embodiment that allows the door to swing entirely out of the way of the door portal.

FIG. 3 illustrates a preferred embodiment of the trackless bi-fold door 1 in the straight door open configuration. This figure shows the rear side the trackless bi-fold door 1. This figure shows the trackless bi-fold door 1 attached to the doorjamb 3 via doorjamb hinges 7.

This figure illustrates the extension mechanism, the spring 9, which holds the door panels 2 in the straight door open configuration. This figure illustrates a pair of springs 9 located at both the top and bottom of the door panels 2. However, springs 9 can be located at the top, at the bottom, or at both the top and bottom of the door panels 2. This embodiment uses bungee chords as the springs 9. When the door panels 2 are in the closed bi-fold configuration the springs 9 are under tension. When the door panels 2 are separated, the springs 9 pull the door panels 2 to the straight door open configuration. Likewise, when the trackless bi-fold door 1 is moved to the closed configuration, the springs 9 hold the door panels 2 such that they are straight and do not bulge out at door panel hinge 5.

Cutouts 6 are also shown. Cutouts 6 allow the springs 9 to flex without interference from the door panels 2.

Spring apertures 8 provide access to the springs 9 such that they can be initially installed, and/or replaced if necessary. Likewise, a cover (not shown) can be installed over the aperture 8 for cosmetic reasons.

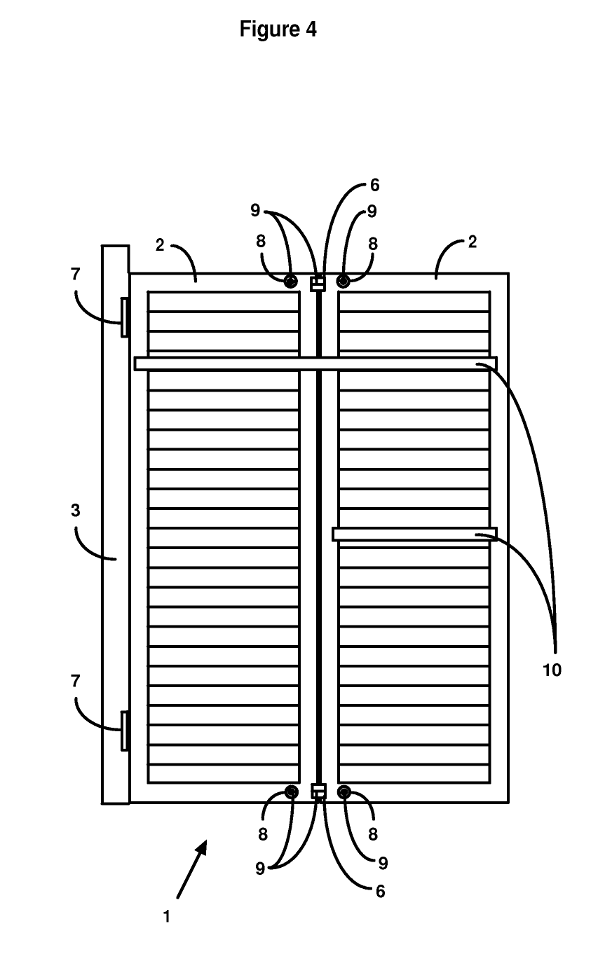

FIG. 4 illustrates an alternative preferred embodiment of the trackless bi-fold door 1 in the straight door open configuration showing optional storage racks 10 secured to the back of the trackless bi-fold door 1. In situations where space allows the trackless bi-fold door 1 to be kept in the straight door open configuration, storage racks 10 can be secured to the rear of door panels 2 such that extra storage space can be obtained. The storage racks 10 can be permanently attached or removable. When removable, they are detachably attached to the door panels. If the storage racks 10 attach to only one door panel 2. They can be left attached permanently, and if a storage rack 10 is wide enough to span both doors, then it must be detached before the bi-fold door 1 is placed in the bi-fold position. Of course, if left permanently attached, the storage rack 10 must be sized so as to not interfere with the placement of the bi-fold door 1 in the bi-fold position.

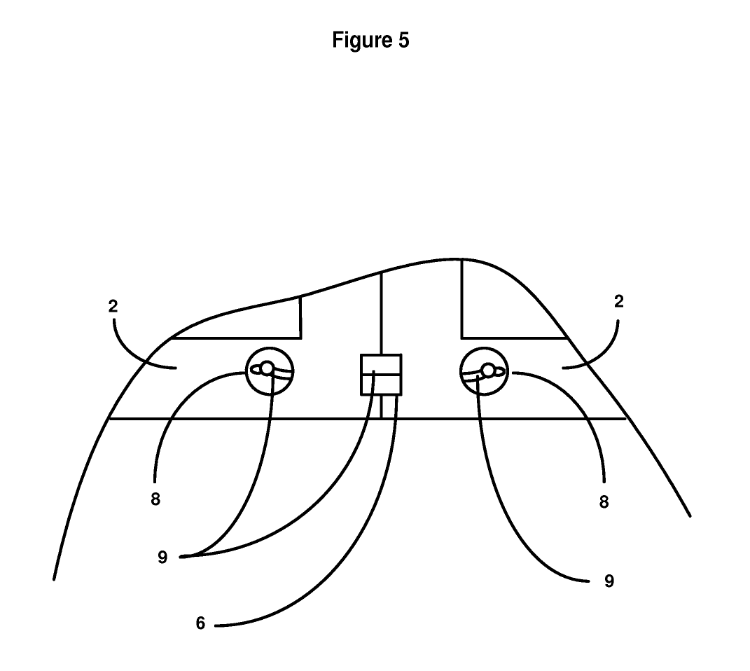

FIG. 5 illustrates a preferred embodiment of the spring mechanism 9 in the trackless bi-fold door 1 that retains the door panels 2 in the bi-fold or straight door configurations. In this embodiment, apertures are drilled in the edges of the door panels 2 and a bungee cord is fed through from one door panel to the adjacent door panel 2. The bungee cord in this embodiment functions as the spring 2. When the door panels 2 are folded into the bi-fold position, the cutout 6 allows the spring 9 to flex without interference from the door panels 2. While not required, the channel that the spring 2 is inserted into can be formed as a smooth surface to reduce friction while the bi-fold door 1 is being folded or unfolded.

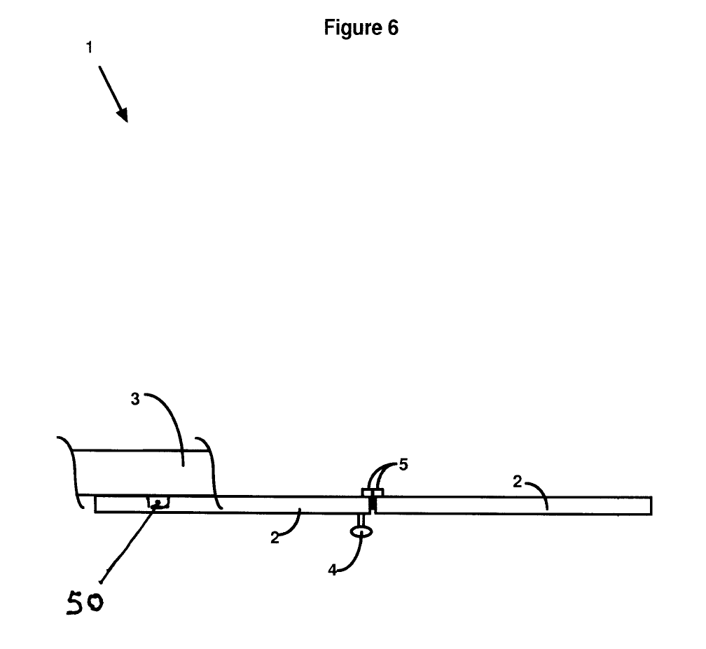

FIG. 6 illustrates a top view of a preferred embodiment of the trackless bi-fold door 1 positioned against the doorjamb 3.

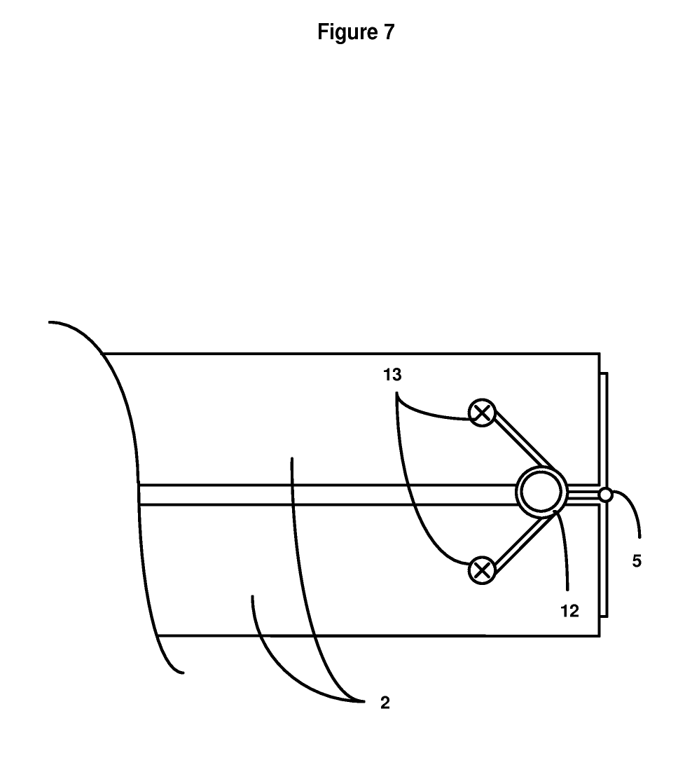

FIG. 7 illustrates an end view of an alternative preferred embodiment of the trackless bi-fold door 1 in which the spring mechanism is a conventional spring 12 in place of the bungee spring 9 shown in the embodiment of FIG. 5. The spring 12 can be secured to the top or bottom edge of the door panels 12, or to both the top and bottom edges of the door panels 2. The spring 12 is shown secured to the door panels 2 by screws 13. Those skilled in the art will recognize that any suitable spring mechanism can be used for the purposes of the invention. For ease of illustration, the springs 12 is shown exposed, but in practice the spring(s) 12 would be concealed for cosmetic purposes.

The foregoing embodiments illustrate the general features and operation of the invention. However, those skilled in the art will recognize that various modifications can be made without departing from the spirit and scope of the invention. For example, a number of alternative embodiments to the spring can be made, as follows:

1. Smaller spring mechanisms 9 can be secured to the top and/or bottom of the bi-fold door 1 rather than mortised into the bi-fold door 1 as illustrated above in FIG. 5.

2. A pincher spring attached to the top and/or bottom or mortised into the door as an alternative to the bungee-based spring mechanism 9.

3. A conventional metal spring, for example a helical spring, could be used as the spring mechanism 9 on the top, bottom, or both the top and bottom of the bi-fold door 1 or mortised into the bi-fold door 1.

4. A mousetrap style spring could also be used, as the spring mechanism on the top, the bottom of the bi-fold door 1 or mortised into it.

As can be seen, the invention allows a bi-fold door 1 to be used as a single panel conventional door as well as a bi-fold door 1.

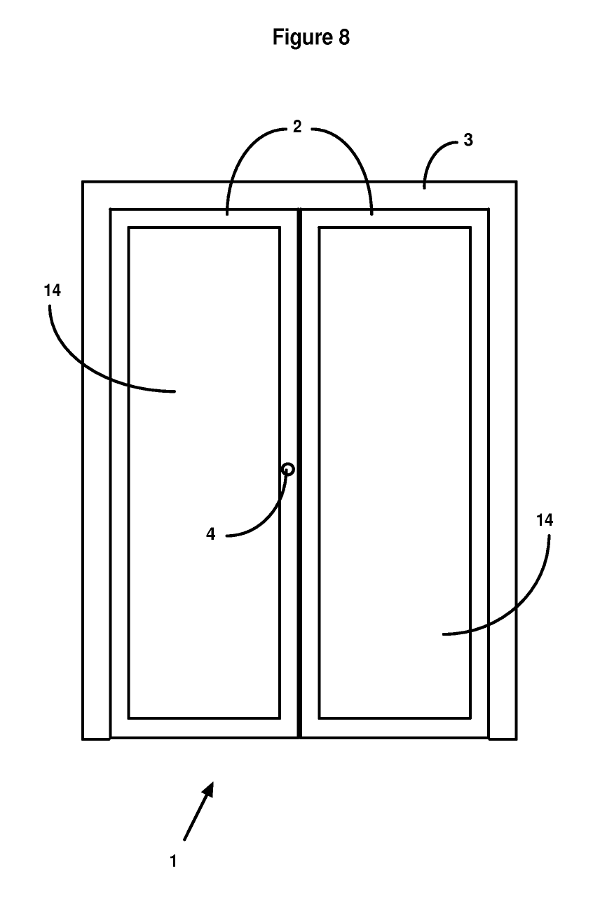

FIG. 8 illustrates a front view of an alternative preferred embodiment of the trackless bi-fold door 1 in which the conventional slats on the trackless bi-fold door 1, shown in previous embodiments, are replaced by solid panels 14 that can be fabricated using mirrors, artwork, or other materials. Further, the solid panels 14 can be replaceable, such that they can be changed at will for aesthetic reasons.

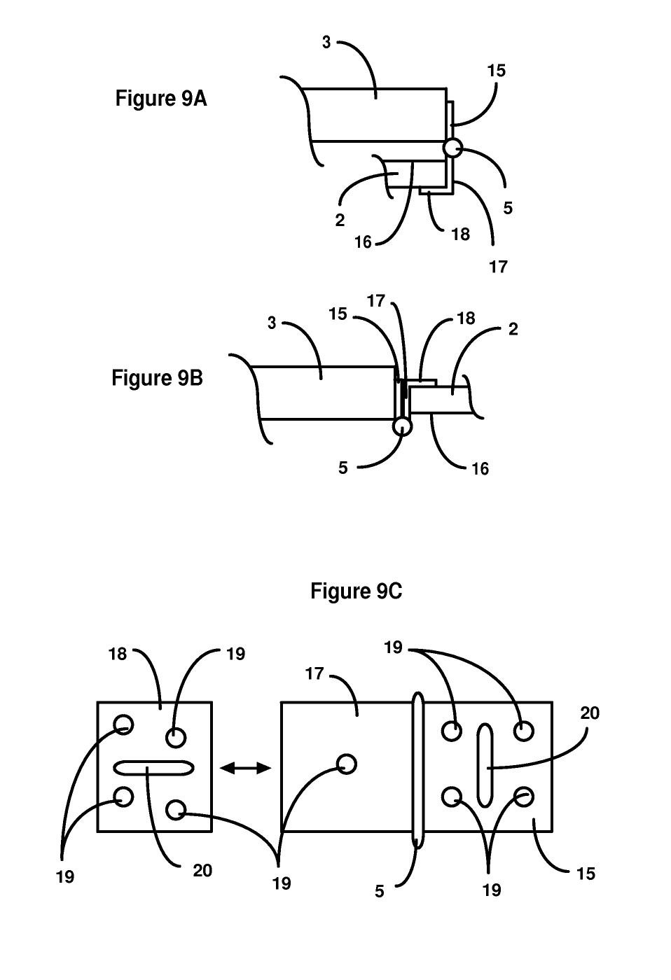

FIG. 9A illustrates top edge views of an alternative preferred embodiment of the trackless bi-fold door 1 in which a unique hinge 5 moves the door panels entirely out of the way of the entry to the storage area that the trackless bi-fold door 1 covers when it is closed. In this figure the trackless bi-fold door 1 is shown in the open configuration. As a result, the user has the same access through the door that would be available if the trackless bi-fold door 1 did not exist.

In this figure, the hinge 5 has a doorjamb extension 15 that is secured to the doorjamb 3. In the preferred embodiment, the doorjamb extension 15 is secured to the doorjamb 3 via screws (not shown), but any other suitable method can be used. Also shown is door extension 17 that secures to the edge of door panel 2. Door extension 17 also has a lateral extension 18 that extends in a perpendicular angle from the plane of lateral door extension 18. This arrangement allows door extension 17 and lateral extension 18 to both be secured, preferably via screws to both the edge and rear surface of door panel 2, thereby providing improved stability.

FIG. 9B illustrates the door panel 2 in the closed configuration. The figure illustrates a significant advantage of the invention, namely, the new hinge 5 structure allows the trackless bi-fold door 1 to swing 180 degrees such that it is moved completely out of the way of the door portal.

In FIG. 9C, a front view of the preferred embodiment of the hinge 5 used by the trackless bi-fold door 1 is shown. Hinge 5 has doorjamb extension 15 that extends outward from hinge 5. While the preferred embodiment shows four screw apertures 19 and an adjustment slot 20, those skilled in the art will recognize that the number of apertures 19 can vary and the adjustment slot 20 can be optional. This adjustment slot 20 is oriented in the vertical direction and is used to adjust the vertical height of the trackless bi-fold door 1 prior to securing the trackless bi-fold door 1 to the doorjamb 3.

Door extension 17 extends from the other side of hinge 5. This figure only illustrates a single screw aperture 19, but that number can vary. The front surface of lateral door extension 18 is also shown. In this figure, four screw apertures 19 are shown. As was the case above, this number can vary. A horizontally oriented adjustment slot 20 is also shown, and is used to adjust the position of trackless bi-fold door 1 prior to securing it with screws via screw apertures 19.

As can be seen from FIGS. 9A-C, the hinge 5 allows the door panel 2 to swing entirely out of the way of the door portal. As a result, the user has unobstructed access to the area inside the portal.

While specific embodiments have been discussed to illustrate the invention, it will be understood by those skilled in the art that variations in the embodiments can be made without departing from the spirit of the invention. The types of materials used can vary, the method of attachment can vary, the spring can be implemented by any suitable spring mechanism, etc. Therefore, the invention shall be limited solely to the scope of the claims.

I Claim:

1. A trackless bi-fold door, comprising:
at least two door panels, the door panels hingedly connected to one another via at least one door panel hinge;
a retention mechanism that secures the two panels together in a bi-fold configuration;
the retention mechanism comprising a first retention portion attached to one of the door panels, and a second retention portion attached to the other door panel; the first and second retention portions secured to the door panels such that they align with one another and secure together when the door panels are folded into the bi-fold configuration;
an extension mechanism that secures the two panels in a straight door configuration when the retention mechanism is released;
the extension mechanism further comprising first and second extension mechanisms, the extension mechanisms being secured to the door panels through a channel in the door panels, the first extension mechanism positioned at the bottom of the door panels and the second extension mechanism positioned at the top of the door panels;
whereby the trackless bi-fold door can be transitioned between a single door configuration and a bi-fold door configuration.

2. (canceled)

3. A trackless bi-fold door, as in claim 1, wherein: the extension mechanism mechanism is a bungee cord.

4. (canceled)

5. A trackless bi-fold door, as in claim 4, wherein: the trackless bi-fold door further comprises first and second spring mechanisms, a first spring mechanism positioned at the bottom of the door panels, and the second spring mechanism positioned at the top of the door panels.

6. A trackless bi-fold door, as in claim 2, wherein: the spring mechanism is a mechanical spring.

7. A trackless bi-fold door, as in claim 6, wherein: the trackless bi-fold door further comprises first and second spring mechanisms, a first spring mechanism positioned at the bottom of the door panels, and the second spring mechanism positioned at the top of the door panels.

8. (canceled)

9. A trackless bi-fold door, as in claim 1, wherein: the first and second portions of the retention mechanism are magnetic.

10. (canceled)

11. A trackless bi-fold door, as in claim 3, further comprising: at least one storage rack detachably attached to one or more door panels.

12. (canceled)

13. A trackless bi-fold door, comprising:
at least one door panel, the door panel hingedly attachable to a doorjamb by at least one door hinge;
the hinge having a doorjamb extension suitable for attachment to a doorjamb, an opposing door extension suitable for attachment to a first side of the door panel;
the hinge, further comprising a lateral door extension that extends from the door extension and secures to a second side of the door panel; and the hinge positioned such that when the trackless bi-fold door is opened, the door panel is movable substantially out of the way of the entire door portal;
whereby the trackless bi-fold door extends away from the doorjamb such that access to through the door is not limited by the trackless bi-fold door.

14. (canceled)

15. A trackless bi-fold door, comprising:
at least two door panels, the door panels hingedly connected to one another by at least one door panel hinge;
a retention mechanism that secures the two panels together in a bi-fold configuration;
the retention mechanism comprising a first retention portion attached to one of the door panels, and second retention mechanism attached to the other door panel;
the first and second retention portions secured to the door panels such that they align with one another and secure tog ether when the door panels are folded into the bi-fold configuration, the retention mechanism being a bungee cord;
an extension mechanism that secures the two panels in a straightdoor configuration when the retention mechanism is released;
the extension mechanism further comprising first and second extension mechanisms, the extension mechanisms being secured to the door panels through a channel in the door panels, the first extension mechanism positioned at the bottom of the door panels and the second extension mechanism positioned at the top of the door panels;
one door panel hingedly attachable to a doorjamb by the door hinge;
the door hinge having a doorjamb extension suitable for attachment to a doorjamb, an opposing door extension suitable for attachment to a first side of the door panel;
the hinge, further comprising a lateral door extension that extends from the door extension and secures to a second side of the door panel; and
the hinge positioned such that when the trackless bi-fold door is opened, the door panel is movable substantially out of the way of the entire door portal such that access to through the door is not limited by the trackless bi-fold door.

16. The trackless bi-fold door as described in claim 15, further comprising a storage rack detachably attached to one of the door panels.
